(19) United States
(12) Patent Application Publication
(10) Pub. No.: US 2025/0321885 A1
(43) Pub. Date: Oct. 16, 2025

(54) INDIRECT MEMORY ACCESS USING SHARED POINTER

(71) Applicant: Micron Technology, Inc., Boise, ID (US)

(72) Inventor: David Andrew Roberts, Wellesley, MA (US)

(21) Appl. No.: 19/174,159

(22) Filed: Apr. 9, 2025

Related U.S. Application Data
(60) Provisional application No. 63/632,279, filed on Apr. 10, 2024.

(51) Int. Cl. G06F 12/02; G06F 12/084; G06F 13/16

(52) U.S. Cl. CPC G06F 12/0246; G06F 12/084; G06F 13/1657

(57) ABSTRACT

System and techniques for indirectly accessing an object in memory are described herein. A memory allocation request for an object is received that specifies use of a shared pointer. A memory address to fulfill this allocation is identified and a pointer to this address is written in a shared memory location accessible by both a host and a memory device. When the host requests the object, the host references the pointer to get the memory address of the object for the request. The memory device can then return the requested data.

### PRIORITY APPLICATION

This application claims the benefit of priority to U.S. Provisional Application Ser. No. 63/632,279, filed Apr. 10, 2024, which is incorporated herein by reference in its entirety.

### TECHNICAL FIELD

Embodiments described herein generally relate to memory control in a computing device and more specifically to indirect memory access using shared pointer.

### BACKGROUND

Memory address translation in a typical computer is a technique that involves converting virtual memory addresses (e.g., generated by processor instructions) into physical addresses in the computer's main (e.g., working) memory (e.g., random access memory (RAM)). Memory address translation enables efficient memory management or process isolation in modern operating systems. Generally, a Central Processing Unit (CPU) executes programs using virtual addresses, which are then translated to actual physical memory addresses through a system known as the Memory Management Unit (MMU). The MMU uses data structures like page tables, maintained by the operating system, to map virtual addresses to physical addresses. Usually, each entry in the page table corresponds to a block of memory, known as a page. The translation involves locating the page table entry that corresponds to the virtual address, and then combining the physical address base from this entry with the offset from the virtual address to form the complete physical address. This mechanism allows for features like virtual memory, where parts of a program can be stored on disk when not in use, and memory protection, ensuring that one process cannot access the memory of another.

Cache coherency typically ensures consistency of data stored in local caches of different CPUs, cores, or other devices (e.g., memory device, co-processor, etc.) of a computing system. When multiple devices access and modify shared data, there's a risk of having different, inconsistent copies of the data in caches of these devices, leading to errors and inconsistencies in program execution. Cache coherency protocols, such as MESI (Modified, Exclusive, Shared, Invalid) protocol, can be employed to address consistency issues among caches of shared data. These protocols aim to ensure that any changes made to data in one cache are either immediately reflected in other caches or that other caches are invalidated or updated accordingly. This is often achieved through communication and coordination between the caches, where caches send signals or messages to inform other caches (e.g., or devices) about read or write operations. If one cache modifies data, the protocol propagates this change to other caches, either by updating copies at the other caches or marking the copies as invalid, ensuring all caches have a consistent view of the data.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for indirect memory access using shared pointer, according to an embodiment.

FIG. 2 illustrates an example of an arrangement of a shared memory, a memory device, and a host device, according to an embodiment.

FIG. 3 illustrates an example of a host connected to a CXL device, according to an embodiment.

FIG. 4 illustrates a flow diagram of an example of a method for indirect memory access using shared pointer, according to an embodiment.

FIG. 5 is a block diagram illustrating an example of a machine upon which one or more embodiments may be implemented.

### DETAILED DESCRIPTION

In typical computing systems that use virtual memory, address translation and data mapping overhead tends to increase as system memory capacity increases. Operating system (OS) page tables traditionally maintain user application to physical memory mappings. These page tables are secured against unauthorized changes and so updates usually involve privileged execution mode switches (e.g., changing from a non-privileged execution mode to a privileged execution mode) to perform computationally expensive page table manipulations. Usually, these manipulations are restricted to relatively coarse grained (e.g., large data segment) aspects of the memory, such as at four kilobyte page sizes. Thus, traditional virtual memory approaches tend to be computationally expensive, rely on host processor intervention, and result in coarse grained changes to memory mappings.

To address these issues, an indirect memory access using a shared pointer can be used. Here, a user program accesses memory via a pointer to enable a level of indirection in the memory accesses. This enables another device, such as a CXL memory device, to move data to new memory locations and to update the pointer to enable the user program to continue to access the data. In an example, the pointer is involved in a cache coherency arrangement with a host processor. Here, a mechanism, such as exists in the CXL standard, provides for changes to the pointer to be reflected across various devices participating in the cache coherency. Thus, for example, when the memory device updates the pointer locally, the host processor is informed of the change by the virtue of the pointer being maintained in an area that is shared via the cache-coherency mechanism.

The indirect memory access described herein provides several benefits over traditional virtual memory techniques. For example, the technique is lightweight, involving less hardware and processing by a host system than is typical in virtual memory techniques. The indirect memory access also enables finer grained changes to be made by enabling the pointer to point to a variable size data segment. In this example, an array of pointers can represent parts of the user program data and any one of these pointers can be updated to reflect a data move. With respect to host flexibility, the present indirect memory access can provide a shared array of memory object locks and pointers between the host processor and the memory device in user space. A segment of address space (e.g., covering multiple memory tiers) can be provided to an application to represent a contiguous virtual address space. Here, either the host or the memory device can allocate or remap objects in the virtual address space by modifying the shared pointers. When the memory device includes atomic operators, the memory device can use atomic memory operations to ensure consistency of updates to the shared object pointers.

Data tiering and tier management is a motivation to enable the memory device to control data movement. In data tiering, data can be moved to different storage media depending upon a variety of factors. For example, if the data is small, frequently accessed, and low latency is important, the data can be housed in static random access memory (SRAM). In contrast, if the data is large, infrequently accessed, and latency is unimportant, the data can be stored in NAND flash memory or magnetic tape as a cost-effective solution. With mixed media capabilities accessible by memory device controllers based on new physical or access protocols, such as CXL, such memory tiering can be handled by the memory device given the indirect memory access described herein. Additional details and examples are given below.

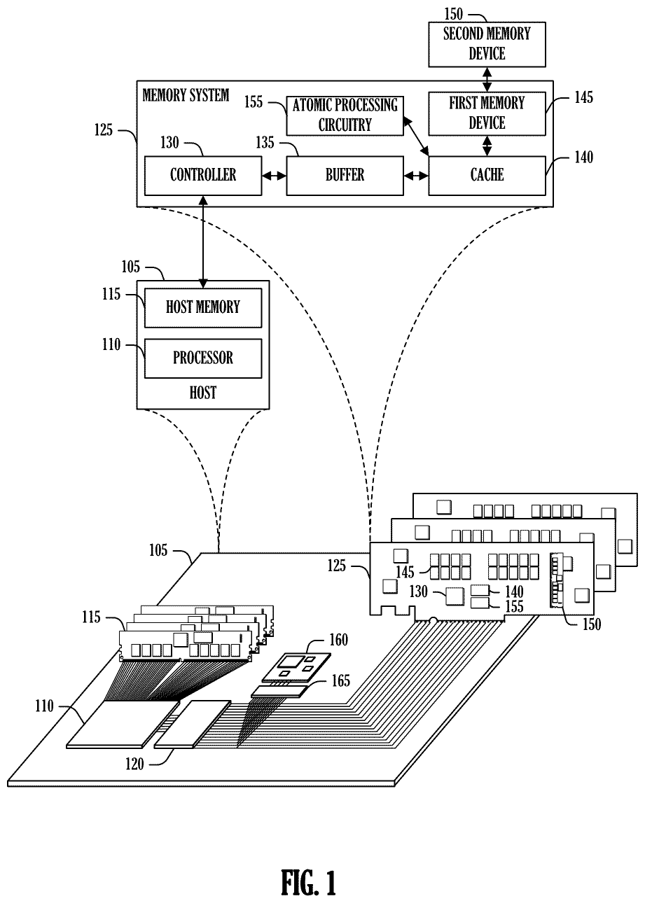

FIG. 1 is a block diagram of an example of an environment including a system 105 for indirect memory access using shared pointer, according to an embodiment. The system 105 includes a first host 110 (e.g., central processing unit (CPU)) and a second host 160 (e.g., an accelerator), and a memory system 125. The first host 110 may have directly attached host memory 115 in the system 105. In an example, the system 105 is, or is part of, a server computer, workstation, personal laptop computer, a desktop computer, a digital camera, a smart phone, a memory card reader, Internet-of-thing enabled device, or the like. The first host 110 or the second host 160 can include one or more processor cores, a system of parallel processors, or other CPU arrangements.

The memory system 125 includes a controller 130, a buffer 135 (e.g., internal state memory), a cache 140, and a first memory device 145. The first memory device 145 can include, for example, one or more memory modules (e.g., single in-line memory modules, dual in-line memory modules, etc.). The first memory device 145 can include volatile memory or non-volatile memory. The first memory device 145 can include a multiple-chip device that comprises one or multiple different memory types or modules. In an example, the system 105 includes a second memory device 150 that interfaces with the memory system 125 and the first host 110.

The system 105 can include a backplane and can include a number of processing resources (e.g., one or more processors, microprocessors, or some other type of controlling circuitry) including, or in addition to, the first host 110 and the second host 160. The system 105 can optionally include separate integrated circuits for the first host 110, the second host 160, the memory system 125, the controller 130, the buffer 135, the cache 140, the first memory device 145, the second memory device 150, any one or more of which can comprise respective chiplets that can be connected and used together. In an example, the system 105 includes a server system or a high-performance computing (HPC) system or a portion thereof. Embodiments of the first host 110, or other components of the system 105, can be implemented in Von Neumann or in non-Von Neumann architectures, which can include one or more components (e.g., CPU, abstract logic unit (ALU), etc.) often associated with a Von Neumann architecture, or can omit these components.

In an example, the first memory device 145 can provide a main memory for the system 105, or the first memory device 145 can comprise accessory memory or storage for use by the system 105. In an example, the first memory device 145 or the second memory device 150 includes one or more arrays of memory cells, e.g., volatile or non-volatile memory cells. The arrays can be flash arrays with a NAND architecture, for example. Embodiments are not limited to a particular type of memory device. For instance, memory devices can include RAM, ROM, DRAM, SDRAM, PCRAM, RRAM, and flash memory, among others.

In embodiments in which the first memory device 145 includes persistent or non-volatile memory, the first memory device 145 can include a flash memory device such as a NAND or NOR flash memory device. The first memory device 145 can include other non-volatile memory devices such as non-volatile random-access memory devices (e.g., NVRAM, ReRAM, FeRAM, MRAM, PCM). Some memory devices—such as a ferroelectric RAM (FeRAM) devices that include ferroelectric capacitors—can exhibit hysteresis characteristics, such as a 3-D Crosspoint (3D XP) memory device, or combinations thereof.

In an example, the interface 120, or the interface 165, can include any type of communication path, bus, interconnect, or the like, that enables information to be transferred between the first host 110 or the second host 160 respectively, or other devices of the system 105, and the memory system 125. Non-limiting examples of interfaces can include a peripheral component interconnect (PCI) interface, a peripheral component interconnect express (PCIe) interface, a serial advanced technology attachment (SATA) interface, a Universal Serial Bus (USB) interface, a Thunderbolt interface, or a miniature serial advanced technology attachment (mSATA) interface, among others. In an example, the interface 120 includes a PCIe 5.0 interface that is compliant with the compute express link (CXL) protocol standard. Accordingly, in some embodiments, the interface 120 supports transfer speeds of at least 32 GT/s.

CXL is a high-speed central processing unit (CPU)-to-device and CPU-to-memory interconnect designed to enhance compute performance. CXL maintains memory coherency between the CPU memory space (e.g., the host memory 115 or caches maintained by the first host 110) and memory on attached devices or accelerators (e.g., the first memory device 145 or the second memory device 150). This arrangement enables resource sharing at higher performance, reduced software stack complexity, and lower overall system cost than other interconnect arrangements. CXL is an industry open standard interface for high-speed communications to accelerators that are increasingly used to complement CPUs in support of emerging data-rich and compute-intensive applications such as artificial intelligence and machine learning. The memory system 125 is illustrated with atomic processing circuitry 155 as an accelerator in order to perform near-memory operations. In general, the atomic memory operations (AMOs) performed by the atomic processing circuitry 155 include such small operations as incrementing a number at a memory address or multiplying a number in two memory addresses, etc. While AMOs are generally used for such operations, the manipulation of memory is not so restricted. For example, modern artificial neural network architectures generally involve the application of small additive or multiplicative operations or thresholding across vast swaths of artificial neurons. Because the computations are usually simple, but the data large, near memory execution of such operations is possible and beneficial given the illustrated architecture.

In an example, the controller 130 comprises a media controller such as a non-volatile memory express (NVMe) controller. The controller 130 can be configured to perform operations such as copy, write, read, error correct, etc. for the first memory device 145. In an example, the controller 130 can include purpose-built circuitry or instructions to perform various operations. That is, in some embodiments, the controller 130 can include circuitry or can be configured to perform instructions to control movement of data or addresses associated with data such as among the buffer 135, the cache 140, or the first memory device 145 or the second memory device 150.

In an example, the buffer 135 comprises a data buffer circuit that includes a region of a physical memory used to temporarily store data, for example, while the data is moved from one place to another. The buffer 135 can include a first-in, first-out (FIFO) queue in which the oldest (e.g., the first-in) data is processed first. In some embodiments, the buffer 135 includes a hardware shift register, a circular buffer, or a list.

In an example, the cache 140 comprises a region of a physical memory used to temporarily store particular data from the first memory device 145 or the second memory device 150. Generally, the cache 140 provides faster access to data than the backing memory. The cache 140 can include a pool of data entries. In an example, the cache 140 can be configured to operate according to a write-back policy in which data is written to the cache without being concurrently written to the first memory device 145. Accordingly, in some embodiments, data written to the cache 140 does not have a corresponding data entry in the first memory device 145. This can occur when, for example, data is written to the cache and deleted before a write-back is triggered to write the data into the first memory device 145, for example.

In an example, the cache 140 is implemented as a multi-way associative cache. Here, cache entries are divided by some portion of a memory address (e.g., a set number of significant bits). A group of cache entries (e.g., cache lines or ways), called a cache set herein, can be co-associated with a same bit-set from the memory address. Usually, the number of ways in a cache set is less than the total number of memory addresses to which the ways are associated. Thus, a way can be evicted to be associated with a new memory address in the range at various points.

In an example, the controller 130 can receive write requests involving the cache 140 and cause data associated with each of the write requests to be written to the cache 140. The controller 130 can similarly receive read requests and cause data that is stored in, for example, the first memory device 145 or the second memory device 150, to be retrieved and written to, for example, the first host 110 via the interface 120 or the second host 160 via the interface 165. In an example, the controller 130 processes all requests for memory it controls through the cache 140. Thus, a read request will first check the cache 140 to determine if the data is already cached. If not, a read to the first memory device 145 is made to retrieve the data. The data is then written to the cache 140. In an example, the data is then read from the cache 140 and transmitted to the requesting entity, such as the first host 110 or the second host 160. Working exclusively through the cache can simplify some elements of the controller 130 hardware at the cost of a little latency.

To implement indirect memory access using a shared object pointer, the controller 130 can be configured to receive a memory allocation request for an object. This request specifies use of a shared pointer. Because the user program will dereference the actual memory location from the pointer rather than simply use the actual memory location, the user program, or whatever entity is making the memory request, is actively participating in the selection of the indirect memory access over other memory access techniques. Thus, the request explicitly specifies the use of the shared pointer.

The term “object” here represents a data entity as defined by the requestor (e.g., the user program). Thus, such an object can be a struct, a value (e.g., a string, an integer, etc.), an executable block (e.g., a function, method, etc.), an image, or another data structure. There is no requirement that the object align with traditional memory segmentation values. Thus, the object does not need to be divisible by the traditional four kilobyte page size of other allocation techniques.

The controller 130 is configured to identify a memory address that is part of memory (e.g., the first memory device 145) used to fulfill the memory allocation. Here, as part of execution of the memory allocation request for the object, the controller 130 identifies what storage is available (e.g., from the first memory device 145, the second memory device 150, or from a fabric attached memory device) and reserves that storage to satisfy the request. The elements of the memory used to satisfy the requests have addresses that are collected by the controller 130 at this stage.

In an example, the memory used to fulfill the memory allocation is tiered memory. In an example, the tiered memory includes multiple tiers of performance. As mentioned above, tiered memory divides memory into performance tiers. Generally, lower latency (e.g., data seek time, data access time, etc.) results in a higher tier memory technology. Often, such storage media are expensive to produce, occupy more physical area, or use more energy to operate than other storage media. For example, SRAM is typically much faster (e.g., lower latency) than flash storage, but SRAM is more expensive per byte and thus typically limited in total storage space. In such an arrangement, the SRAM is a higher tier than the flash storage. As illustrated, the first memory device 145 can be higher tier than the second memory device 150.

The controller 130 is configured to write a pointer to the memory address (e.g., memory addresses in an array that represents the memory allocation for the object) is written into a shared memory location. The shared memory location is accessible by the first host 110 and the memory system 125. In an example, the shared memory location is subject to a cache coherence mechanism between the first host 110 and the memory system 125. In an example, the memory system 125 is attached to the host via a Compute Express Link (CXL) interconnect, such as the interface 120 in an example.

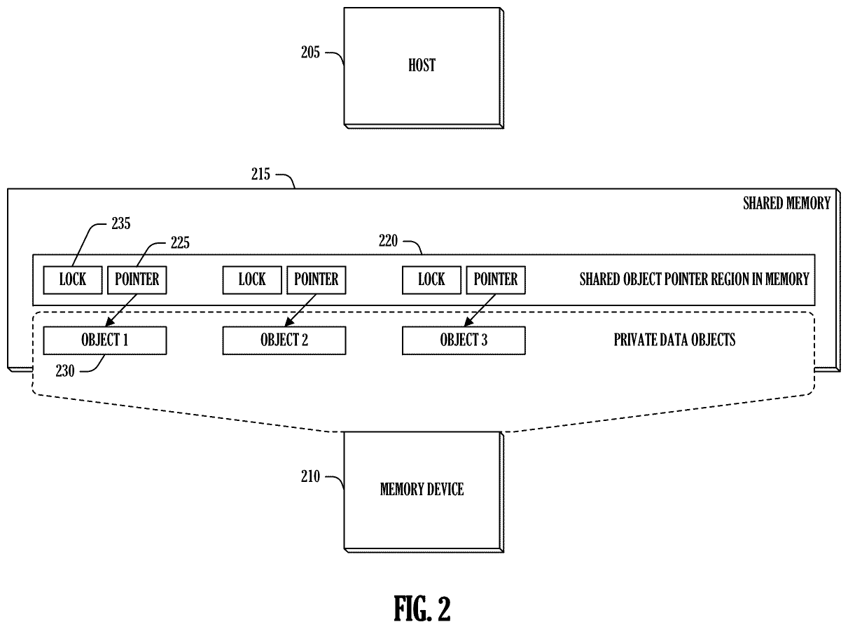

In an example, the controller 130 is configured to maintain the pointer (e.g., an array of pointers) in a data structure. In an example, the data structure includes a lock for the object. An example of the structure is illustrated in FIG. 2. In an example, the lock specifies which of the first host 110 or the memory system 125 can update the pointer in the data structure. In an example, the data structure includes a size for the object. This facilitates fine-grained allocation and storage movement by the controller 130.

In an example, a portion of the memory used to fulfill the memory allocation is managed by a second memory device. This example occurs in situations where a memory address space is shared across several memory systems, as can occur in Global Fabric Attached Memory (GFAM) devices. In this case, the controller 130 can allocate memory in the second device using a shared address space between the two memory systems.

The controller 130 is configured to receive a request from the first host 110 for the memory used to fulfill the memory allocation. This request includes the memory address as read by the host from the pointer. Here, the user program, running on the first host 110, has accessed the pointer to obtain the memory address of the object. The object is then requested by the address.

The controller 130 is configured to return the data at the memory used to fulfill the memory allocation based on the request from the first host 110. This completes the set and response procedure for the indirect memory access using the shared object pointer.

A situation can arise in which requests from the first host 110 are pending at the memory system 125 when the pointer is updated. Thus, when these requests are executed, the memory address in the request no longer points to the object data. To address this issue, the controller 130 can update the memory address in requests that are queued. For example, the queued requests can be searched for the previous memory address and updated (e.g., rewritten) to the new memory address.

Accordingly, in an example, the controller 130 is configured to move data in the memory used to fulfill the memory allocation to second memory—the second memory corresponding to a second memory address—and to update the pointer to point to the second memory address. The controller 130 is configured to then update a set of requests pending at the memory system 125 for the memory address from the first memory address to the second memory address. In an example, to update the set of requests, the controller 130 is configured to rewrite the memory address to the second memory address. This rewrite-in-place technique is generally feasible because the memory system 125 has the pending requests and is also performing the data move.

Other techniques can be used to remedy issues when the pointer address is changed. For example, to update the set of requests, the controller 130 is configured to translate the memory address to the second memory address when executing members of the set of requests. Here, the controller 130 can version the pointer address and correspond requests to the version. Thus, if the request being executed corresponds to a previous version of the pointer, the request is fulfilled using the current version of the pointer. In an example, the requests can be queued based on the object and merely use the current pointer address for the object.

In an example, the controller 130 is configured to deny a second memory request based on receiving a second memory request from the host after the data in the memory used to fulfill the memory allocation has begun moving and before the pointer is updated to point to the second memory address. This example provides an alternative to address rewriting by simply denying the memory request when the data is in a state of flux. Typically, the memory request failure will prompt another attempt by the first host 110 to acquire the data and, if the move is complete, the request will be handled with the new pointer address now pointing to the correct data.

FIG. 2 illustrates an example of an arrangement of a shared memory 215, a memory device 210, and a host device 205, according to an embodiment. The illustrated arrangement includes an established pointer array that is shared between the host device 205 and the memory device 210. The host device 205 can write to a configuration register (CSR) of the memory device 210 or a mailbox memory region in a near-memory compute processor in a memory module (NMC) to inform the memory device 210 where (e.g., how) to access the shared pointer array 220.

The pointer 225 includes a memory address of an object 230 (e.g., points to the object 230). The object 230 is private to the memory device 210 because the object 230 can only be accessed by the host device 205 via the pointer 225. Otherwise, the address of the object 230 is not provided to the host device 205 in contrast to traditional virtual memory techniques. In an example, a pointer 225 in the pointer array 220 can include a corresponding lock 235 (e.g., lock flag) that indicates whether the host device 205 or the memory device 210 is manipulating the pointer 225. In an example, only when the lock 235 has been acquired by the host device 205 or the memory device 210, can the pointer 225 be changed. The change (e.g., an update to the pointer 225) can occur, for example, after the memory device 210 has relocated the data for the object 230 into a different memory location, such as a different internal storage tier, or a peer memory device (e.g., via peer-to-peer data copying). In an example, when the object 230 is moved (e.g., the data copy is complete), the lock 235 is cleared.

In an example, the data structure represented by the pointer array 220 can include an object size indicator field. This can enable either the host device 205 or the memory device 210 to move the object 230 as a whole. The ability to move the entire object can have several benefits, such as avoiding splitting the object, which can break contiguity in the address space or break correct program execution.

To make use of the pointer 225, the host device 205, and more specifically the programs that execute thereon, change behavior to access the object 230 using the pointer 225 as opposed to the traditional memory addressing. Accordingly, a programmer, compiler, or interpreter adjusts program output to request the memory address from the pointer 225 rather than managing memory offsets internally.

In the illustrated arrangement, the memory device 210 is freed to reprogram any object pointers for data that is beneficial (e.g., under operating tests or metrics) to move in the address space. Because object relocation of heavily used objects to higher-tier media improves system performance while moving lightly used objects to lower-tier media frees higher-tier media for heavily used objects, this ability can increase the operating efficiency of the memory device 210.

Generally, any device where the data resides can move the object inside or across devices when that device updates pointers afterwards. The user (e.g., host device 205, program, etc.) operates in the same manner whether or not the data is moved because the access involves the pointer 225 that points to the object 230 wherever that object resides.

In an example, hardware or software coherency is used to ensure that a consistent value of the pointer 225 is seen by operators (e.g., the host device 205 and the memory device 210). For example, the memory device 210 moving the object 230 can lock the pointer 225, copy the data to a new destination—either aborting or buffering any writes that occur during migration—and update the pointer 225. At this point, the memory device 210 would invalidate any cached copies the pointer 225 by, for example, using CXL.cache or CXL.mem back-invalidate commands inherent in the protocol. Once done, the memory device 210 can release the lock 235.

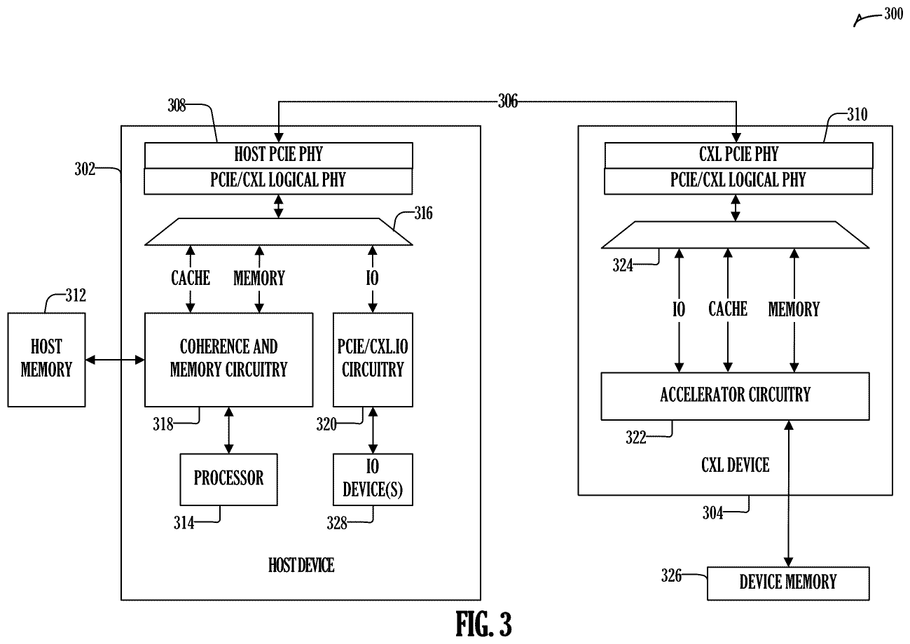

FIG. 3 illustrates an example of a host connected to a CXL device, according to an embodiment. FIG. 3 illustrates generally an example of a CXL system 300 that uses a CXL link 306 to connect a host device 302 and a CXL device 304 via a host physical layer PCIE interface 308 and a CXL client physical layer PCIE interface 310 respectively. In an example, the host device 302 comprises or corresponds to the first host 110 (or the second host 160) and the CXL device 304 comprises or corresponds to the memory system 125 from the example of the system 105 in FIG. 1. A memory system command manager can comprise a portion of the host device 302 or the CXL device 304. In an example, the CXL link 306 can support communications using multiplexed protocols for caching (e.g., CXL.cache), memory accesses (e.g., CXL.mem), and data input/output transactions (e.g., CXL.io). CXL.io can include a protocol based on PCIe that is used for functions such as device discovery, configuration, initialization, I/O virtualization, and direct memory access (DMA) using non-coherent load-store, producer-consumer semantics. CXL.cache can enable a device to cache data from the host memory (e.g., from the host memory 312) using a request and response protocol. CXL.memory can enable the host device 302 to use memory attached to the CXL device 304, for example, in or using a virtualized memory space. In an example, CXL.memory transactions can be memory load and store operations that run downstream from or outside of the host device 302.

In the example of FIG. 3, the host device 302 includes a host processor 314 (e.g., comprising one or more CPUs or cores) and IO device(s) 328. The host device 302 can comprise, or can be coupled to, host memory 312. The host device 302 can include various circuitry (e.g., logic) configured to facilitate CXL-based communications and transactions with the CXL device 304. For example, the host device 302 can include coherence and memory circuitry 318 configured to implement transactions according to CXL.cache and CXL.mem semantics, and the host device 302 can include PCIe circuitry 320 configured to implement transactions according to CXL.io semantics. In an example, the host device 302 can be configured to manage coherency of data cached at the CXL device 304 using, e.g., its coherence and memory circuitry 318.

The host device 302 can further include a host multiplexer 316 configured to modulate communications over the CXL link 306 (e.g., using the PCIe PHY layer). The multiplexing of protocols ensures that latency-sensitive protocols (e.g., CXL.cache and CXL.memory) have the same or similar latency as a native processor-to-processor link. In an example, CXL defines an upper bound on response times for latency-sensitive protocols to help ensure that device performance is not adversely impacted by variation in latency between different devices implementing coherency and memory semantics.

In an example, symmetric cache coherency protocols can be difficult to implement between host processors because different architectures can use different solutions, which in turn can compromise backward compatibility. CXL can address this problem by consolidating the coherency function at the host device 302, such as using the coherence and memory circuitry 318.

The CXL device 304 can include an accelerator device that comprises various accelerator circuitry 322. In an example, the CXL device 304 can comprise, or can be coupled to, CXL device memory 326. The CXL device 304 can include various circuitry configured to facilitate CXL-based communications and transactions with the host device 302 using the CXL link 306. For example, the accelerator circuitry 322 can be configured to implement transactions according to CXL.cache, CXL.mem, and CXL.io semantics. The CXL device 304 can include a CXL device multiplexer 324 configured to control communications over the CXL link 306. The accelerator circuitry 322 can be one or more processors that can perform one or more tasks. Accelerator circuitry 322 can be a general-purpose processor or a processor designed to accelerate one or more specific workloads. The illustrated accelerator circuitry 322 can implement the hybrid coherency mechanism described above (e.g., in FIG. 1 and FIG. 2).

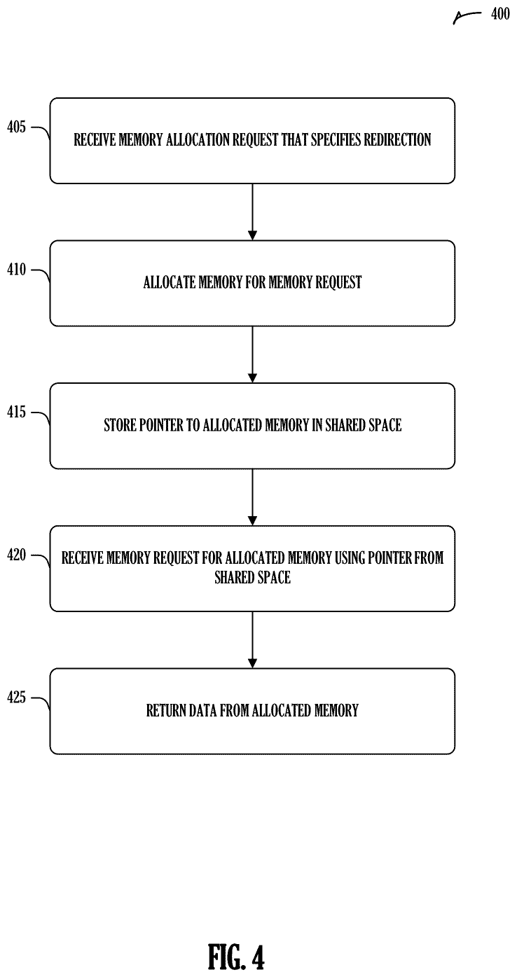

FIG. 4 illustrates a flow diagram of an example of a method 400 for indirect memory access using shared pointer, according to an embodiment. The operations of the method 400 are performed by computing hardware, such as that described above or below (e.g., processing circuitry).

At operation 405 a request for a memory allocation for an object is received at a memory device. This request specifies use of a shared pointer.

At operation 410, a memory address that is part of memory used to fulfill the memory allocation is identified. In an example, the memory used to fulfill the memory allocation is tiered memory, the tiered memory including multiple tiers of performance.

At operation 415, a pointer to the memory address is written into a shared memory location, the shared memory location being accessible by a host and the memory device. In an example, the shared memory location is subject to a cache coherence mechanism between the host and the memory device. In an example, the memory device is attached to the host via a Compute Express Link (CXL) interconnect.

In an example, the pointer is maintained in a data structure. In an example, the data structure includes a lock for the object. In an example, the lock specifies which of the host or the memory device can update the pointer in the data structure. In an example, the data structure includes a size for the object. In an example, a portion of the memory used to fulfill the memory allocation is managed by a second memory device.

At operation 420, a request from the host for the memory used to fulfill the memory allocation is received. This request includes the memory address as read by the host from the pointer.

At operation 425, data at the memory used to fulfill the memory allocation is returned based on the request from the host.

In an example, the method 400 includes the operations of moving data in the memory used to fulfill the memory allocation to second memory—the second memory corresponding to a second memory address—and updating the pointer to point to the second memory address. In an example, the operations also include updating a set of requests pending at the memory device for the memory address to the second memory address. In an example, updating the set of requests includes rewriting the memory address to the second memory address. In an example, updating the set of requests includes translating the memory address to the second memory address when executing members of the set of requests.

In an example, the operations to the method 400 include denying a second memory request based on receiving a second memory request from the host after the data in the memory used to fulfill the memory allocation has begun moving and before the pointer is updated to point to the second memory address.

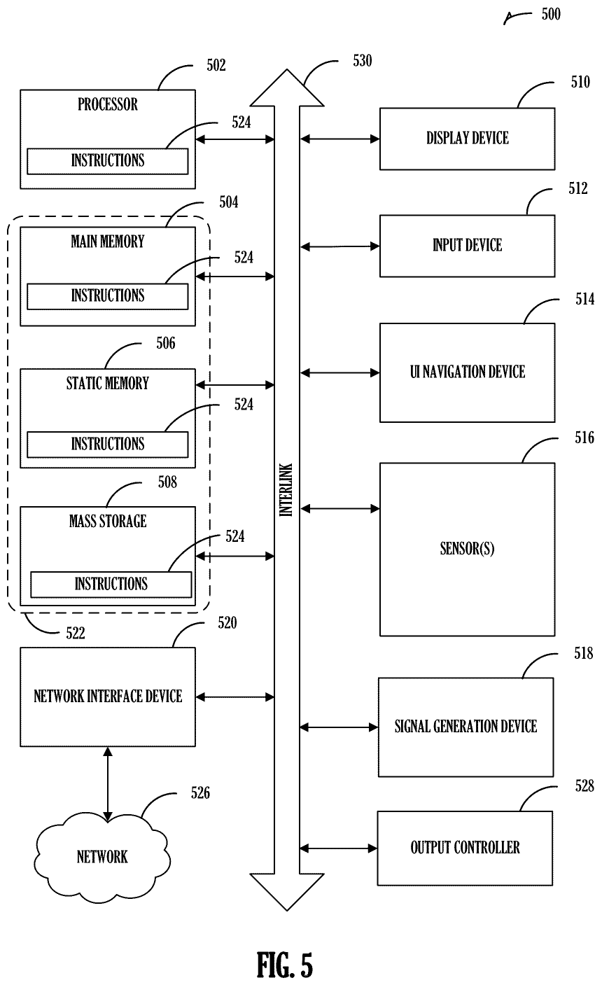

FIG. 5 illustrates a block diagram of an example machine 500 upon which any one or more of the techniques (e.g., methodologies) discussed herein may perform. Examples, as described herein, may include, or may operate by, logic or a number of components, or mechanisms in the machine 500. Circuitry (e.g., processing circuitry) is a collection of circuits implemented in tangible entities of the machine 500 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 500 follow.

In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 500 may include a hardware processor 502 (e.g., a central processing unit (CPU), a graphics processing unit (GPU), a hardware processor core, or any combination thereof), a main memory 504, a static memory (e.g., memory or storage for firmware, microcode, a basic-input-output (BIOS), unified extensible firmware interface (UEFI), etc.) 506, and mass storage 508 (e.g., hard drives, tape drives, flash storage, or other block devices) some or all of which may communicate with each other via an interlink (e.g., bus) 530. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 508, a signal generation device 518 (e.g., a speaker), a network interface device 520, and one or more sensors 516, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 502, the main memory 504, the static memory 506, or the mass storage 508 may be, or include, a machine readable medium 522 on which is stored one or more sets of data structures or instructions 524 (e.g., software) embodying or utilized by any one or more of the techniques or functions described herein. The instructions 524 may also reside, completely or at least partially, within any of registers of the processor 502, the main memory 504, the static memory 506, or the mass storage 508 during execution thereof by the machine 500. In an example, one or any combination of the hardware processor 502, the main memory 504, the static memory 506, or the mass storage 508 may constitute the machine readable media 522. While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 522 may be representative of the instructions 524, such as instructions 524 themselves or a format from which the instructions 524 may be derived. This format from which the instructions 524 may be derived may include source code, encoded instructions (e.g., in compressed or encrypted form), packaged instructions (e.g., split into multiple packages), or the like. The information representative of the instructions 524 in the machine readable medium 522 may be processed by processing circuitry into the instructions to implement any of the operations discussed herein. For example, deriving the instructions 524 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 524.

In an example, the derivation of the instructions 524 may include assembly, compilation, or interpretation of the information (e.g., by the processing circuitry) to create the instructions 524 from some intermediate or preprocessed format provided by the machine readable medium 522. The information, when provided in multiple parts, may be combined, unpacked, and modified to create the instructions 524. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 524 may be further transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software. A transmission medium is a machine readable medium.

### ADDITIONAL NOTES & EXAMPLES

Example 1 is an apparatus for indirect memory access using a shared object pointer, the apparatus comprising: an interface to a memory device; and processing circuitry that, when in operation, is configured to: receive a request for a memory allocation for an object, the request specifying use of the shared pointer; identify a memory address that is part of memory, accessible via the interface, used to fulfill the memory allocation; writing a pointer to the memory address into a shared memory location, the shared memory location being accessible by a host and the memory device; receive a request from the host for the object, the request including the memory address as read by the host from the pointer; and return data, retrieved via the interface, at the memory used to fulfill the memory allocation based on the request from the host.

In Example 2, the subject matter of Example 1, wherein the processing circuitry is configured to: move data in the memory used to fulfill the memory allocation to second memory, the second memory corresponding to a second memory address; and update the pointer to point to the second memory address.

In Example 3, the subject matter of Example 2, wherein the processing circuitry is configured to update a set of requests pending at the memory device for the memory address to the second memory address.

In Example 4, the subject matter of Example 3, wherein, to update the set of requests, the processing circuitry is configured to rewrite the memory address to the second memory address.

In Example 5, the subject matter of any of Examples 3-4, wherein, to update the set of requests, the processing circuitry is configured to translate the memory address to the second memory address when executing members of the set of requests.

In Example 6, the subject matter of any of Examples 2-5, wherein the processing circuitry is configured to deny a second memory request based on receiving a second memory request from the host after the data in the memory used to fulfill the memory allocation has begun moving and before the pointer is updated to point to the second memory address.

In Example 7, the subject matter of any of Examples 1-6, wherein the shared memory location is subject to a cache coherence mechanism between the host and the memory device.

In Example 8, the subject matter of Example 7, wherein the memory device is attached to the host via a Compute Express Link (CXL) interconnect.

In Example 9, the subject matter of any of Examples 1-8, wherein the memory used to fulfill the memory allocation is tiered memory, the tiered memory including multiple tiers of performance.

In Example 10, the subject matter of any of Examples 1-9, wherein the pointer is maintained in a data structure, the data structure including a lock for the object, the lock specifying which of the host or the memory device can update the pointer in the data structure.

In Example 11, the subject matter of Example 10, wherein the data structure includes a size for the object.

In Example 12, the subject matter of any of Examples 1-11, wherein a portion of the memory used to fulfill the memory allocation is managed by a second memory device.

Example 13 is a method for indirect memory access using a shared object pointer, the method comprising: receiving, at a memory device, a request for a memory allocation for an object, the request specifying use of the shared pointer; identifying a memory address that is part of memory used to fulfill the memory allocation; writing a pointer to the memory address into a shared memory location, the shared memory location being accessible by a host and the memory device; receiving a request from the host for the object, the request including the memory address as read by the host from the pointer; and returning data at the memory used to fulfill the memory allocation based on the request from the host.

In Example 14, the subject matter of Example 13, comprising: moving data in the memory used to fulfill the memory allocation to second memory, the second memory corresponding to a second memory address; and updating the pointer to point to the second memory address.

In Example 15, the subject matter of Example 14, comprising updating a set of requests pending at the memory device for the memory address to the second memory address.

In Example 16, the subject matter of Example 15, wherein updating the set of requests includes rewriting the memory address to the second memory address.

In Example 17, the subject matter of any of Examples 15-16, wherein updating the set of requests includes translating the memory address to the second memory address when executing members of the set of requests.

In Example 18, the subject matter of any of Examples 14-17, comprising denying a second memory request based on receiving a second memory request from the host after the data in the memory used to fulfill the memory allocation has begun moving and before the pointer is updated to point to the second memory address.

In Example 19, the subject matter of any of Examples 13-18, wherein the shared memory location is subject to a cache coherence mechanism between the host and the memory device.

In Example 20, the subject matter of Example 19, wherein the memory device is attached to the host via a Compute Express Link (CXL) interconnect.

In Example 21, the subject matter of any of Examples 13-20, wherein the memory used to fulfill the memory allocation is tiered memory, the tiered memory including multiple tiers of performance.

In Example 22, the subject matter of any of Examples 13-21, wherein the pointer is maintained in a data structure, the data structure including a lock for the object, the lock specifying which of the host or the memory device can update the pointer in the data structure.

In Example 23, the subject matter of Example 22, wherein the data structure includes a size for the object.

In Example 24, the subject matter of any of Examples 13-23, wherein a portion of the memory used to fulfill the memory allocation is managed by a second memory device.

Example 25 is a machine readable medium including instructions for indirect memory access using a shared object pointer, the instructions, when executed by processing circuitry, cause the processing circuitry to perform operations comprising: receiving, at a memory device, a request for a memory allocation for an object, the request specifying use of the shared pointer; identifying a memory address that is part of memory used to fulfill the memory allocation; writing a pointer to the memory address into a shared memory location, the shared memory location being accessible by a host and the memory device; receiving a request from the host for the object, the request including the memory address as read by the host from the pointer; and returning data at the memory used to fulfill the memory allocation based on the request from the host.

In Example 26, the subject matter of Example 25, wherein the operations comprise: moving data in the memory used to fulfill the memory allocation to second memory, the second memory corresponding to a second memory address; and updating the pointer to point to the second memory address.

In Example 27, the subject matter of Example 26, wherein the operations comprise updating a set of requests pending at the memory device for the memory address to the second memory address.

In Example 28, the subject matter of Example 27, wherein updating the set of requests includes rewriting the memory address to the second memory address.

In Example 29, the subject matter of any of Examples 27-28, wherein updating the set of requests includes translating the memory address to the second memory address when executing members of the set of requests.

In Example 30, the subject matter of any of Examples 26-29, wherein the operations comprise denying a second memory request based on receiving a second memory request from the host after the data in the memory used to fulfill the memory allocation has begun moving and before the pointer is updated to point to the second memory address.

In Example 31, the subject matter of any of Examples 25-30, wherein the shared memory location is subject to a cache coherence mechanism between the host and the memory device.

In Example 32, the subject matter of Example 31, wherein the memory device is attached to the host via a Compute Express Link (CXL) interconnect.

In Example 33, the subject matter of any of Examples 25-32, wherein the memory used to fulfill the memory allocation is tiered memory, the tiered memory including multiple tiers of performance.

In Example 34, the subject matter of any of Examples 25-33, wherein the pointer is maintained in a data structure, the data structure including a lock for the object, the lock specifying which of the host or the memory device can update the pointer in the data structure.

In Example 35, the subject matter of Example 34, wherein the data structure includes a size for the object.

In Example 36, the subject matter of any of Examples 25-35, wherein a portion of the memory used to fulfill the memory allocation is managed by a second memory device.

Example 37 is a system for indirect memory access using a shared object pointer, the system comprising: means for receiving, at a memory device, a request for a memory allocation for an object, the request specifying use of the shared pointer; means for identifying a memory address that is part of memory used to fulfill the memory allocation; means for writing a pointer to the memory address into a shared memory location, the shared memory location being accessible by a host and the memory device; means for receiving a request from the host for the object, the request including the memory address as read by the host from the pointer; and means for returning data at the memory used to fulfill the memory allocation based on the request from the host.

In Example 38, the subject matter of Example 37, comprising: means for moving data in the memory used to fulfill the memory allocation to second memory, the second memory corresponding to a second memory address; and means for updating the pointer to point to the second memory address.

In Example 39, the subject matter of Example 38, comprising means for updating a set of requests pending at the memory device for the memory address to the second memory address.

In Example 40, the subject matter of Example 39, wherein the means for updating the set of requests include means for rewriting the memory address to the second memory address.

In Example 41, the subject matter of any of Examples 39-40, wherein the means for updating the set of requests include means for translating the memory address to the second memory address when executing members of the set of requests.

In Example 42, the subject matter of any of Examples 38-41, comprising means for denying a second memory request based on receiving a second memory request from the host after the data in the memory used to fulfill the memory allocation has begun moving and before the pointer is updated to point to the second memory address.

In Example 43, the subject matter of any of Examples 37-42, wherein the shared memory location is subject to a cache coherence mechanism between the host and the memory device.

In Example 44, the subject matter of Example 43, wherein the memory device is attached to the host via a Compute Express Link (CXL) interconnect.

In Example 45, the subject matter of any of Examples 37-44, wherein the memory used to fulfill the memory allocation is tiered memory, the tiered memory including multiple tiers of performance.

In Example 46, the subject matter of any of Examples 37-45, wherein the pointer is maintained in a data structure, the data structure including a lock for the object, the lock specifying which of the host or the memory device can update the pointer in the data structure.

In Example 47, the subject matter of Example 46, wherein the data structure includes a size for the object.

In Example 48, the subject matter of any of Examples 37-47, wherein a portion of the memory used to fulfill the memory allocation is managed by a second memory device.

Example 49 is at least one machine-readable medium including instructions that, when executed by processing circuitry, cause the processing circuitry to perform operations to implement of any of Examples 1-48.

Example 50 is an apparatus comprising means to implement of any of Examples 1-48.

Example 51 is a system to implement of any of Examples 1-48.

Example 52 is a method to implement of any of Examples 1-48.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. An apparatus for indirect memory access using a shared object pointer, the apparatus comprising:
an interface to a memory device; and
processing circuitry that, when in operation, is configured to:
receive a request for a memory allocation for an object, the request specifying use of the shared pointer;
identify a memory address that is part of memory, accessible via the interface, used to fulfill the memory allocation;
writing a pointer to the memory address into a shared memory location, the shared memory location being accessible by a host and the memory device;
receive a request from the host for the object, the request including the memory address as read by the host from the pointer; and
return data, retrieved via the interface, at the memory used to fulfill the memory allocation based on the request from the host.

2. The apparatus of claim 1, wherein the processing circuitry is configured to:
move data in the memory used to fulfill the memory allocation to second memory, the second memory corresponding to a second memory address; and
update the pointer to point to the second memory address.

3. The apparatus of claim 2, wherein the processing circuitry is configured to update a set of requests pending at the memory device for the memory address to the second memory address.

4. The apparatus of claim 3, wherein, to update the set of requests, the processing circuitry is configured to rewrite the memory address to the second memory address.

5. The apparatus of claim 3, wherein, to update the set of requests, the processing circuitry is configured to translate the memory address to the second memory address when executing members of the set of requests.

6. The apparatus of claim 2, wherein the processing circuitry is configured to deny a second memory request based on receiving a second memory request from the host after the data in the memory used to fulfill the memory allocation has begun moving and before the pointer is updated to point to the second memory address.

7. The apparatus of claim 1, wherein the shared memory location is subject to a cache coherence mechanism between the host and the memory device.

8. The apparatus of claim 1, wherein the memory used to fulfill the memory allocation is tiered memory, the tiered memory including multiple tiers of performance.

9. The apparatus of claim 1, wherein the pointer is maintained in a data structure, the data structure including a lock for the object, the lock specifying which of the host or the memory device can update the pointer in the data structure.

10. The apparatus of claim 9, wherein the data structure includes a size for the object.

11. A non-transitory machine readable medium including instructions for indirect memory access using a shared object pointer, the instructions, when executed by processing circuitry, cause the processing circuitry to perform operations comprising:
receiving, at a memory device, a request for a memory allocation for an object, the request specifying use of the shared pointer;
identifying a memory address that is part of memory used to fulfill the memory allocation;
writing a pointer to the memory address into a shared memory location, the shared memory location being accessible by a host and the memory device;
receiving a request from the host for the object, the request including the memory address as read by the host from the pointer; and
returning data at the memory used to fulfill the memory allocation based on the request from the host.

12. The non-transitory machine readable medium of claim 11, wherein the operations comprise:
moving data in the memory used to fulfill the memory allocation to second memory, the second memory corresponding to a second memory address; and
updating the pointer to point to the second memory address.

13. The non-transitory machine readable medium of claim 12, wherein the operations comprise updating a set of requests pending at the memory device for the memory address to the second memory address.

14. The non-transitory machine readable medium of claim 13, wherein updating the set of requests includes rewriting the memory address to the second memory address.

15. The non-transitory machine readable medium of claim 13, wherein updating the set of requests includes translating the memory address to the second memory address when executing members of the set of requests.

16. The non-transitory machine readable medium of claim 12, wherein the operations comprise denying a second memory request based on receiving a second memory request from the host after the data in the memory used to fulfill the memory allocation has begun moving and before the pointer is updated to point to the second memory address.

17. The non-transitory machine readable medium of claim 11, wherein the shared memory location is subject to a cache coherence mechanism between the host and the memory device.

18. The non-transitory machine readable medium of claim 11, wherein the memory used to fulfill the memory allocation is tiered memory, the tiered memory including multiple tiers of performance.

19. The non-transitory machine readable medium of claim 11, wherein the pointer is maintained in a data structure, the data structure including a lock for the object, the lock specifying which of the host or the memory device can update the pointer in the data structure.

20. The non-transitory machine readable medium of claim 19, wherein the data structure includes a size for the object.
